(19) United States
(12) Patent Application Publication
(10) Pub. No.: US 2007/0254085 A1
(43) Pub. Date: Nov. 1, 2007

(54) Condiment Composition Based on Grated Cheese

(75) Inventors: Carlo Alberto Bertozzi, Parma (IT); Carlo Cotti, Parma (IT)

Correspondence Address: MERCHANT & GOULD PC, P.O. BOX 2903, MINNEAPOLIS, MN, 55402-0903, US

(73) Assignee: SOCIETA' PER AZIONI ABELE BERTOZZI, PARMA (IT)

(21) Appl. No.: 11/587,745

(22) PCT Filed: Apr. 27, 2005
(86) PCT No.: PCT/IB05/51377

§ 371 Date: Oct. 27, 2006

(30) Foreign Application Priority Data
Apr. 28, 2004 (IT) TO2004A000263

(51) Int. Cl. A23L 1/221; A01J 27/04; A23C 19/14

(52) U.S. Cl. 426/582; 426/519; 426/650

(57) ABSTRACT

A condiment composition comprising a high percentage of grated cheese in combination with a core of other lyophilised and/or dehydrated ingredients capable of imparting taste and/or flavour to the foodstuff to which the composition is applied and with a binding base comprising glucose syrup, vegetable fat and milk proteins is described. The binding base makes it possible to obtain a homogeneous composition which is readely soluble on contact with the moisture released by the food being dressed.

The present invention relates to a new instant ready-for-use condiment composition based on grated cheese, preferably Parmigiano Reggiano, and a method for its preparation.

In particular the invention relates to a condiment composition as defined in the preamble of claim 1. This condiment composition comprises a high percentage of grated cheese in combination with a core of other dehydrated and/or lyophilised ingredients capable of imparting specific predetermined flavour and/or taste characteristics to the food to which the condiment is applied.

The inventors have however observed that the mere mixing of a fatty protein component with a high water content such as grated cheese with the abovementioned ingredients having a low or zero water content and a variety of chemical, physical and organoleptic properties would result in a final product which is devoid of the properties of creaminess, softness, uniformity and solubility which are desirable in a condiment composition.

One object of the present invention is therefore to provide a condiment based on grated cheese which is suitable for applying to almost any type of food (for example pasta, vegetables, meat, soups, etc.), which enhances the taste and nutritional characteristics of the cheese (preferably Parmigiano Reggiano), and which is capable of conferring added value upon the product through the flavours imparted by the dehydrated vegetables, but which has a homogeneous, soft and creamy consistency at the same time.

Another object of the present invention is to provide a condiment characterised by great ease and speed of use which has at the same time a long storage life.

The presence of dehydrated or lyophilised ingredients in the condiment according to the invention permits a long storage life, in that it very greatly reduces the activity of the water (aw) and the percentage moisture content of the product (with a final result of 10-15%) while at the same time also ensuring great speed and ease of use in that, because of the characteristics of the dehydrated or lyophilised ingredients, contact with water is all that is necessary for the condiment to be rehydrated and be ready immediately.

However, the problem in providing a condiment based on Parmigiano Reggiano or any other grated cheese is that of successfully combining the lipophilic nature of the grated cheese with the hydrophilic nature of both the dehydrated or lyophilised ingredients and the great majority of foodstuffs (meat, pasta, vegetables, etc.).

Another object of the present invention is therefore that of providing a condiment based on grated cheese (preferably Parmigiano Reggiano) and a core of other dehydrated or lyophilised ingredients (preferably dehydrated green vegetables). which has in itself a soft, uniform and creamy consistency and which also maintains these properties when applied to the food being dressed.

These and other objects are achieved through a condiment composition according to the preamble of claim 1, characterised in that it also comprises a binding base consisting of glucose syrup, vegetable fat and milk proteins in combination, said binding base being capable of binding the lipophilic ingredients and the hydrophilic ingredients of the condiment together.

The inventors have found that use of the abovementioned binding base surprisingly makes it possible to bind the cheese together with the other ingredients of the composition in an optimum way, thus making it possible to obtain a composition having a soft, uniform and creamy consistency. At the same time the binding base advantageously favours the solubility of the core ingredients once the condiment comes into contact with the foodstuff being dressed. The condiment according to the invention therefore has considerable capacity as a condiment.

The abovementioned properties of the binding base are wholly unexpected because this combination of ingredients, although in itself known, has hitherto been used for entirely different food applications, in particular in hot drinks such as coffee, tea and hot chocolate, which do not give rise to any problems with homogenisation of the components or, apparently, solubility problems.

In a preferred embodiment the condiment composition of the invention as defined above comprises at least 50% by weight of grated cheese (preferably from 50% to 60%) and at least 9% by weight of the binding base (preferably from 9% to 10%), with reference to the total weight of the composition. The grated cheese is preferably grated Parmigiano Reggiano. The dehydrated or lyophilised ingredients are preferably selected from the group consisting of flavourings, herbs, spices, cheese, pine nuts, dried fruit, vegetables, vegetable fibre, potatoes, mushrooms and combinations thereof.

The percentage composition of the binding base present in the condiment composition of the invention is preferably as follows:
approximately 50% by weight of glucose syrup,
approximately 35% by weight of vegetable fat (for example refined palm or coconut fat),
approximately 15% by weight of milk proteins.

The milk proteins are preferably proteins obtained by coagulation.

The condiment composition of the invention is prepared by mixing the grated cheese, the binding base and the core of lyophilised and/or dehydrated ingredients in a mixer. It may subsequently be packed in containers suitable for food use, for example sealed containers with an easy-peel opening. Packaging is carried out in a controlled inert gas atmosphere (nitrogen).

The following example is provided purely by way of illustration and is not intended to restrict the scope of the invention as defined in the appended claims.

### EXAMPLE

Three variants of the condiment composition of the present invention, the compositions of which are indicated below, were prepared. The percentage by weight of each ingredient is provided in relation to the total weight of the condiment composition. A binding base comprising 35% refined coconut fat, 50% glucose syrup and 15% whey proteins was used in all three variants.

Condiment with Basil and Pine Nuts

| | |
|---|---|
| fresh grated Parmigiano Reggiano | 57% |
| vegetable fat | 14% |
| binding base | 10% |
| lyophilised basil | 4% |
| sheep milk cheese | 3% |
| iodated salt | 3% |
| pine nuts | 2% |
| cashew nuts | 2% |
| vegetables | 2% |
| vegetable fibre | 2% |
| potatoes | 1% |

Mushroom Condiment

| | |
|---|---|
| fresh grated Parmigiano Reggiano | 58% |
| mushrooms (Agaricus bisporus, | 12% |
| Boletus edulis) | |
| vegetable fat | 10% |
| binding base | 10% |
| vegetables | 4% |
| iodated salt | 3% |
| vegetable fibre | 2% |
| flavouring | 1% |

Ricotta and Tomato Condiment

| | |
|---|---|
| fresh grated Parmigiano Reggiano | 51% |
| tomato | 15% |
| vegetable fat | 9% |
| binding base | 9% |
| vegetables | 5.2% |
| Ricotta | 4% |
| vegetable fibre | 3.5% |
| iodated salt | 3% |
| flavouring | 0.3% |

The products described above have the following special features:
The uniqueness of the product: these are the first condiments based on Parmigiano Reggiano,
Their high serviceability: they are instantaneous and ready for use,
Their extreme versatility: they can be used as condiments for starter courses based on pasta or rice, vegetable soups, consommes, or used to prepare main courses based on meat, eggs, vegetables, etc.,
The quality of the ingredients: they contain a high percentage of Parmigiano Reggiano while at the same time are free from colouring agents and preservatives,
Optimum preservation: once opened, they will maintain all their properties for at least two weeks if kept in a refrigerator.

1. A condiment composition based on grated cheese, comprising grated cheese in combination with a core of other lyophilised and/or dehydrated ingredients capable of conferring taste and/or flavour upon the foodstuff to which the composition is applied, and a binding base consisting of glucose syrup, vegetable fat and milk proteins.

2. The condiment composition according to claim 1, comprising at least 50% by weight of grated cheese and at least 9% by weight of the binding base with reference to the total weight of the composition.

3. The condiment composition according to claim 1, wherein the binding base comprises approximately 50% by weight of glucose syrup, approximately 35% by weight of vegetable fat and approximately 15% by weight of milk proteins with reference to the total weight of the binding base.

4. The condiment composition according to any claim 1, wherein the grated cheese is grated Parmigiano Reggiano.

5. The condiment composition according to claim 1, wherein the vegetable fat is refined coconut or palm fat.

6. The condiment composition according to claim 1, wherein the milk proteins are whey proteins.

7. The condiment composition according to claim 1, wherein said ingredients capable of conferring taste and/or flavour upon the foodstuff to which the condiment composition is applied are selected from the group consisting of flavourings, herbs, spices, cheese, pine nuts, dried fruit, vegetables, vegetable fibre, potatoes, mushrooms and combinations thereof.

8. A method of preparing a condiment composition according to claim 1, comprising mixing the grated cheese in a mixer with the binding base and the lyophilised and/or dehydrated ingredients capable of conferring taste and/or flavour upon the foodstuff to which the condiment composition is applied.

9. A condiment composition according to claim 1, packed in a container.
